(19) United States
(12) Patent Application Publication
(10) Pub. No.: US 2025/0246620 A1
(43) Pub. Date: Jul. 31, 2025

(54) POSITIVE ELECTRODE ACTIVE MATERIAL POWDER AND LITHIUM SECONDARY BATTERY

(71) Applicant: TOYOTA JIDOSHA KABUSHIKI KAISHA, Aichi-ken (JP)

(72) Inventor: Momoko PROCTER, Seto-shi (JP)

(21) Appl. No.: 19/014,219

(22) Filed: Jan. 9, 2025

(30) Foreign Application Priority Data
Jan. 25, 2024 (JP) 2024-009818

(51) Int. Cl. H01M 4/525; C01G 53/50; C01G 53/84; H01M 4/02; H01M 10/052

(52) U.S. Cl. CPC H01M 4/525; C01G 53/50; C01G 53/84; H01M 10/052; C01P 2004/50; C01P 2006/40; H01M 2004/021; H01M 2004/028

(57) ABSTRACT

A positive electrode active material powder includes particles (A) composed of a positive electrode active material. The particles (A) include primary particles (A1) and secondary particles (A2) formed by sintering together primary particles (A1). In a scanning micrograph of a field of view in which 50 or more of the particles (A) are contained, the ratio of coarse secondary particles is 45 number % or less with respect to the total number of the particles (A) in the field of view. The coarse secondary particles are, among the secondary particles (A2), secondary particles (A2) formed by sintering together five or more of the primary particles (A1). The ratio of microparticles is 1.5 number % or less with respect to the total number of the particles (A) in the field of view. The microparticles are, among the particles (A), particles (A) having a circle-equivalent diameter of 0.8 μm or less.

### CROSS-REFERENCE TO RELATED APPLICATION

This application is based on and claims priority under 35 USC 119 from Japanese Patent Application No. 2024-009818 filed on Jan. 25, 2024, the disclosure of which is incorporated by reference herein.

### BACKGROUND

### Technical Field

The present disclosure relates to a positive electrode active material powder and a lithium secondary battery.

### Related Art

Conventionally, from the viewpoint of improving battery performance, the particle size and crystallinity of positive electrode active material powders have been adjusted.

Japanese Patent Application Laid-open (JP-A) No. 2023-001232 discloses a positive electrode active material. The positive electrode active material is a lithium transition metal oxide containing nickel (Ni), cobalt (Co), and manganese (Mn). The content of nickel (Ni) is in a specific range. The lithium transition metal oxide is doped with a doping element. The doping element is at least one selected from the group consisting of B, Zr, Mg, Ti, Sr, W, and Al. The average particle size (D50) after rolling at a specific rolling density is from 4 μm to 10 μm. The positive electrode active material has a single particle form (i.e., primary particles).

In general, single-crystal positive electrode active material powders contain, in addition to primary particles, secondary particles. The secondary particles are formed by sintering together multiple primary particles. When charging or discharging of a lithium secondary battery including a positive electrode containing a positive electrode active material powder is being performed (hereinafter, referred to as “during service”), the interface of secondary particles is susceptible to cracking, producing newly formed surfaces. As a result, deterioration of the positive electrode tends to progress. In addition, the positive electrode active material powder contains multiple microparticles generated at the time of production thereof. Microparticles are particles having a circle-equivalent diameter of 0.8 μm or less, regardless of whether they are primary particles or secondary particles. The microparticles tend to cause interruption of the conductive path in the positive electrode during service. Furthermore, since microparticles have insufficient crystal growth, they are not excellent in structural stability. As a result, there is a possibility that the conventional positive electrode active material powder cannot reduce the resistance increase rate of a lithium secondary battery.

Japanese Patent Application Laid-open (JP-A) No. 2023-001232 does not disclose the ratio of secondary particles and the ratio of microparticles. Therefore, when charging/discharging of a lithium secondary battery including a positive electrode including the positive electrode active material disclosed in Japanese Patent Application Laid-open (JP-A) No. 2023-001232 is repeatedly performed, there is a possibility that the resistance of a lithium secondary battery will tend to increase. Therefore, a positive electrode active material powder that can inhibit an increase in the resistance of a lithium secondary battery even if charging and discharging of a lithium secondary battery are repeatedly performed, is demanded (that is, a positive electrode active material powder capable of reducing the rate of increase in resistance of a lithium secondary battery.)

The present disclosure has been made in view of the above circumstances.

An object of one embodiment of the present disclosure is to provide a positive electrode active material powder which can reduce the rate of increase in resistance of a lithium secondary battery.

It is an object of another embodiment of the present disclosure to provide a lithium secondary battery in which the rate of increase in resistance is reduced.

### SUMMARY

The means for solving the above problem includes the following embodiments.
<1> A positive electrode active material powder of a lithium secondary battery, the powder including plural particles (A) configured by a positive electrode active material, in which: the plural particles (A) include plural primary particles (A1) and plural secondary particles (A2) formed by sintering together primary particles (A1), in a scanning micrograph of the positive electrode active material powder in a field of view containing 50 or more of the particles (A), a ratio of plural coarse secondary particles is 45 number % or lower relative to a total number of the plural particles (A) inside the field of view, the plural coarse secondary particles are, among the plural secondary particles (A2), plural secondary particles formed by sintering together 5 or more of the primary particles (A1), a ratio of plural microparticles is 1.5 number % relative to the total number of the plural particles (A) inside the field of view, and the plural microparticles are, among the plural particles (A), plural particles (A) having a circle equivalent diameter of 0.8 μm or less.
<2> The positive electrode active material powder of <1>, in which: the ratio of the coarse secondary particles is 28 number % or lower relative to the total number of the plural particles (A) inside the field of view, and the ratio of the microparticles is 0.8 number % relative to the total number of the plural particles (A) inside the field of view.
<3> The positive electrode active material powder of <1> or <2>, in which the positive electrode active material is a lithium transition metal oxide having a layered crystalline structure.
<4> The positive electrode active material powder of <3>, in which the lithium transition metal oxide includes at least one of Ni, Co or Mn.
<5> A lithium secondary battery, including a positive electrode including the positive electrode active material powder of any one of <1> to <4>.

According to an embodiment of the present disclosure, a positive electrode active material powder capable of reducing the rate of increase in resistance of a lithium secondary battery is provided.

According to another embodiment of the present disclosure, there is provided a lithium secondary battery having a reduced resistance increase rate.

### BRIEF DESCRIPTION OF DRAWINGS

Exemplary embodiments of the present invention will be described in detail based on the following figures, wherein:

FIG. 1 is a schematic view of primary particles; and

FIG. 2 is a schematic view of secondary particles.

### DETAILED DESCRIPTION

In the present disclosure, a numerical range indicated using “to” means a range in which numerical values described before and after “to” are included as the minimum value and the maximum value, respectively. In the numerical ranges described in the present disclosure in a stepwise manner, the upper limit value or the lower limit value described in a certain numerical range may be replaced with the upper limit value or the lower limit value of another numerical range described in a stepwise manner. In the numerical ranges set forth in the present disclosure, the upper limit value or the lower limit value set forth in a numerical range may be replaced with a value set forth in the examples. In the present disclosure, a combination of two or more preferred embodiments is a more preferred embodiment. In the present disclosure, the amount of each component means the total amount of multiple types of substances, unless otherwise specified, when plural types of substances corresponding to each component are present. In the present disclosure, the term “step” includes not only independent steps but also a situation in which the intended purpose of a step is achieved, even if it is not clearly distinguishable from other steps.

### (1) Positive Electrode Active Material Powder

The positive electrode active material powder of the present disclosure is a positive electrode active material powder of a lithium secondary battery. The positive electrode active material powder includes plural particles (A) configured by a positive electrode active material. The plural particles (A) comprise plural primary particles (A1) and plural secondary particles (A2). The secondary particles (A2) are formed by sintering together primary particles (A1). In a scanning micrograph of the positive electrode active material powder in a field of view (hereinafter, also referred to as a “specific field of view”) in which 50 or more of the particles (A) are contained, the proportion of plural coarse secondary particles (hereinafter, also referred to as the “coarse secondary particle ratio”) is 45 number % or less with respect to the total number of the plural particles (A) in the field of view. The plural coarse secondary particles represent, among the plural secondary particles (A2), plural secondary particles (A2) formed by sintering together 5 or more of the primary particles (A1). The proportion of plural microparticles (hereinafter, also referred to as the “microparticle ratio”) is 1.5 number % or less with respect to the total number of the plural particles (A) in the field of view. The plural microparticles represent, among the plural particles (A), plural particles (A) having a circle-equivalent diameter of 0.8 μm or less.

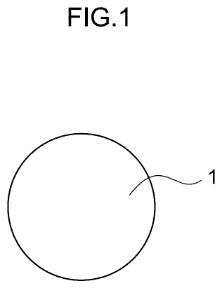

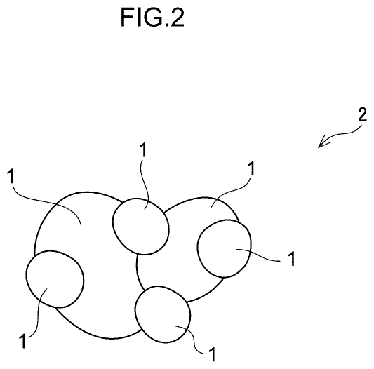

In the present disclosure, “primary particles” refer to particles of a single crystal which are present as the smallest unit of single particles (see FIG. 1). In FIG. 1, the reference numeral “1” denotes a primary particle. A “single crystal” refers to a crystal in which the direction of the crystal does not change. “Secondary particles” refer to particles in which primary particles are sintered together, assuming a single particle shape (see FIG. 2). In FIG. 2, reference numeral “1” denotes a primary particle, and reference numeral “2” denotes a secondary particle. Each of the primary particles and the secondary particles can be identified using an SEM image. “Microparticles” are particles having a circle-equivalent diameter of 0.8 μm or less, regardless of whether they are primary particles or secondary particles. The “circle equivalent diameter” refers to the diameter of a circle having an area equal to the area of the particle. The method for measuring the circle equivalent diameter is the same as the method described in the examples.

Since the positive electrode active material powder of the present disclosure has the above-described configuration, the resistance increase rate of a lithium secondary battery can be reduced.

This effect is assumed to be due to, but not limited to, the following factors.

Generally, when charging/discharging of coarse secondary particles in a positive electrode mixture layer is repeated, there is a possibility that an interface of a coarse secondary particle will crack, increasing the resistance of the lithium secondary battery (hereinafter, also referred to as “battery resistance”). The increase in battery resistance is remarkable when the proportion of coarse secondary particles is large. In addition, when charging and discharging are repeatedly performed, the microparticles in the positive electrode active material tend to be isolated without coming into contact with the surrounding particles, which may increase battery resistance. The increase in battery resistance is remarkable when the proportion of microparticles is large.

However, in the present disclosure, the coarse secondary particle ratio is 45 number % or less. In other words, the coarse secondary particle ratio is low. Furthermore, in the present disclosure, the microparticle ratio is 1.5 number % or less. In other words, the microparticle ratio is low. As a result, it is thought that the positive electrode active material powder of the present disclosure can reduce the resistance increase rate of a lithium secondary battery.

The average particle diameter (D50) of the positive electrode active material powder is not particularly limited, and may be 0.05 μm to 20 μm. The average particle diameter (D50) of the positive electrode active material powder indicates, in a volume-based particle size distribution measured by a particle size distribution analyzer based on laser light diffraction scattering methods, a particle size (particle size distribution D50, median diameter) corresponding to a cumulative 50% by volume from the microparticle side.

### (1.1) Particles (A)

The particles (A) are composed of a positive electrode active material.

The positive electrode active material is preferably a lithium transition metal oxide having a layered crystal structure. As a result, the positive electrode active material powder of the present disclosure can further reduce the resistance increase rate of a lithium secondary battery.

A “lithium transition metal oxide” refers to a compound in which lithium and a transition metal are cations and an oxide ion is an anion. A “transition metal” refers to elements of Groups 3A to 7A, 8 and 1B in the periodic table. A “layered crystal structure” refers to a crystal structure in which a transition metal layer containing lithium and a lithium single layer are alternately layered via oxide ions.

The lithium transition metal oxide preferably contains at least one of nickel (Ni), cobalt (Co), or manganese (Mn). As a result, the positive electrode active material powder of the present disclosure can further reduce the resistance increase rate of a lithium secondary battery.

Examples of the lithium transition metal oxide containing at least one of Ni, Co or Mn include compounds represented by the following (1), LiNiCoMnO₂ (lithium nickel cobalt manganese complex oxide), LiNiO₂ (lithium nickel oxide), LiCoO₂ (lithium cobalt oxide), and LiMn₂O₄ (lithium manganate).
Equation (1): Li₁₊ₓNi_{y}Co_{z}M_{(1-y-z)}M_{γ}O₂

In Formula (1), the relationships 0≤x≤0.2, 0.1<y<0.9, 0.1<z<0.4, and 0≤γ≤0.01 are satisfied. M is at least one additive element selected from the group consisting of Zr, W, Mg, Ca, Na, Fe, Cr, Zn, Si, Sn, Al, B and F.

The plural particles (A) contained in the positive electrode active material powder may be one type or may be at least two types.

The shape of the particle (A) is not particularly limited, and may be, for example, spherical, columnar, or lumpy.

### (1.2) Primary Particles (A1) and Secondary Particles (A2)

The plural particles (A) comprise plural primary particles (A1) and plural secondary particles (A2).

The size of the primary particle (A1) and the size of the secondary particle (A2) are not particularly limited. The average particle diameter (D50) of the primary particles (A1) may be greater than the average particle diameter (D50) of the secondary particles (A2).

The plural secondary particles (A2) contain plural coarse secondary particles.

The coarse secondary particle ratio is 45 number % or less with respect to the total number of the plural particles (A) in a specific field of view. The coarse secondary particle ratio may be 27 number % or less, may be 20 number % or less, may be 15 number % or more, and may be from 15 number % to 45 number %.

Each of the ratio (number %) of the plural primary particles (A1) in the positive electrode active material powder and the ratio (number %) of the plural secondary particles (A2) in the positive electrode active material powder is not particularly limited as long as the coarse secondary particle ratio is 45 number % or less.

### (1.3) Microparticles and Coarse Particles

The plural particles (A) comprise plural microparticles and plural coarse particles. “Coarse particles” refer to plural particles (A) having a circle-equivalent diameter of more than 0.8 μm among the plural particles (A).

The microparticle ratio is 1.5 number % or less with respect to the total number of the plural particles (A) in a specific field of view. The microparticle ratio may be 1.0 number % or less, may be 0.7 number % or more, and may be 0.7 number % to 1.5 number %.

### (1.3) Preferred Embodiment

Preferably, the coarse secondary particle ratio is 28 number % or less with respect to the total number of the plural particles (A) in the field of view, and the microparticle ratio is preferably 0.8 number % or less with respect to the total number of the plural particles (A) in the field of view. As a result, the positive electrode active material powder of the present disclosure can further reduce the resistance increase rate of a lithium secondary battery.

### (2) Lithium Secondary Battery

The lithium secondary battery of the present disclosure includes a positive electrode including the positive electrode active material powder of the present disclosure. Since the lithium secondary battery of the present disclosure has the above-described configuration, the resistance increase rate is reduced.

The lithium secondary battery of the present disclosure usually further includes a negative electrode and an ion conductive medium in addition to the positive electrode. The ion conductive medium is interposed between the positive electrode and the negative electrode and conducts carrier ions. Examples of the ion conductive medium include a nonaqueous electrolyte, a nonaqueous gel electrolyte, a solid ion conductive polymer, and an inorganic solid electrolyte.

Hereinafter, a lithium secondary battery using a nonaqueous electrolytic solution (hereinafter, also referred to as a “nonaqueous battery”) will be described.

### (2.1) Non-Aqueous Battery

A nonaqueous battery includes a positive electrode, a negative electrode, a separator arranged between the positive electrode and the negative electrode, and a nonaqueous electrolytic solution.

### (2.1.1) Positive Electrode

The positive electrode has a positive electrode mixture layer and may further have a positive electrode current collector (for example, aluminum foil). The positive electrode mixture layer is layered on at least one main surface of the positive electrode current collector. The positive electrode mixture layer contains the positive electrode active material powder of the present disclosure.

The positive electrode mixture layer contains the positive electrode active material powder of the present disclosure. The positive electrode mixture layer may further contain a known conductive material (for example, acetylene black, etc.), trilithium phosphate, or a binder (for example, polyvinylidene fluoride (PVDF), etc.).

### (2.1.2) Negative Electrode

The negative electrode has a negative electrode current collector, and may or may not further have a negative electrode mixture layer.

When the negative electrode does not have the negative electrode mixture layer, the negative electrode current collector has a main surface on which lithium metal is deposited during charging. Specifically, lithium ions contained in the nonaqueous electrolytic solution receive electrons on the negative electrode current collector upon charging, whereby lithium metal is deposited. The deposited lithium metal dissolves as lithium ions in the nonaqueous electrolyte solution by discharge. The lithium ions contained in the nonaqueous electrolytic solution may be at least one of ions derived from a lithium salt, which will be described later, or ions supplied from the positive electrode active material by charging.

When the negative electrode has a negative electrode mixture layer, the negative electrode mixture layer is layered on at least one main surface of a negative electrode current collector (for example, a copper foil). The negative electrode mixture layer contains a negative electrode layer active material capable of occluding and releasing a charge carrier (e.g., carbon (e.g., natural graphite), or a compound which can be alloyed with lithium (such as silicon or tin) or the like). The negative electrode mixture layer may further comprise, if necessary, a conductive material for enhancing electron conductivity (for example, acetylene black), a binder such as carboxymethylcellulose (CMC) or styrene butadiene rubber (SBR), an electrolyte-supported salt (lithium salt) for increasing ion conductivity, a polyelectrolyte, or an additive (such as trifluoropropylene carbonate). The negative electrode may have a known configuration.

### (2.1.3) Separator

The separator maintains a space between the positive electrode and the negative electrode to prevent occurrence of a contact short circuit and allows lithium ions to pass through the separator. Examples of the separator include a porous resin sheet and a nonwoven fabric. Examples of the material of the porous resin sheet include polyolefins (for example, polypropylene (PP) or polyethylene (PE)). Examples of the material of the nonwoven fabric include polypropylene, polyethylene terephthalate, and methylcellulose. The separator may have a known configuration.

### (2.1.4) Nonaqueous Electrolytic Solution

The nonaqueous electrolytic solution may contain a nonaqueous solvent and a lithium salt. Examples of lithium salts include LiClO₄, LiAsF₆, LiPF₆, LiBF₄, LiCF₃SO₃, LiN(FSO₂)₂, and LiN(CF₃SO₂)₂. Examples of the nonaqueous solvent include cyclic carbonates (for example, ethylene carbonate (EC)), chain carbonates (such as dimethyl carbonate (DMC) or ethyl methyl carbonate (EMC)), cyclic esters (such as γ-butyrolactone or γ-valerolactone), chain esters (such as methyl formate or methyl acetate), or ethers (such as dimethoxyethane or ethoxymethoxyethane). The nonaqueous electrolytic solution may contain an additive (such as vinylene carbonate or lithium bis(oxalato)borate).

### (2.1.5) Case

Non-aqueous batteries usually have a case. The case houses a positive electrode, a negative electrode, a separator, and a nonaqueous electrolytic solution. The case is not particularly limited, and examples thereof include laminate films (for example, aluminum sheets, etc.), and battery cans (for example, cylindrical, rectangular, or coin-shaped).

### EXAMPLES

Hereinafter, the present disclosure will be described in more detail with reference to examples, but the invention of the present disclosure is not limited to these examples.

### [1] Examples 1-4 and Comparative Examples 1, 2

### [1.1] Crystallization

Nickel sulfate (NiSO₄), cobalt sulfate (CoSO₄), and manganese sulfate (MnSO₄) were dissolved in ion-exchanged water to obtain an aqueous NCM solution. The molar ratio of Ni to Co to Mn (Ni:Co:Mn) (molar ratio) was 8:1:1. The total content of nickel sulfate, cobalt sulfate and manganese sulfate in the aqueous NCM solution was 30% by weight based on the total amount of the aqueous NCM solution.

The gas in the reactor was replaced with nitrogen (N₂). A predetermined amount of aqueous ammonia (NH₃) solution was placed in the reaction vessel, and the solution was stirred at the stirring rate shown in Table 1 with a stirrer. Sodium hydroxide (NaOH) was added into the reaction vessel to make the solution alkaline. The aqueous NCM solution and the NH₃ were added dropwise into the reaction vessel while controlling the pH of the solution to the pH shown in Table 1. The molar ratio of NH₃ to transition metal (i.e., Ni, Co, and Mn) in the aqueous NCM solution was the ratio shown in Table 1 (NH₃/TM). As a result, a crystallized material was precipitated. The crystallized material was removed from the solution by filtration, ion-exchanged water was added thereto, and the mixture was dispersed with a spoon, and washed with water. The resulting water washed product was filtered. The transition metal hydroxide obtained was dried at 120° C. for 16 hours, and the water was evaporated. As a result, a transition metal hydroxide was obtained.

### [1.2] Sintering

The transition metal hydroxide and an Li raw material (Li₂CO₃) were mixed in a mortar. The molar ratio of Li in the Li raw material to the transition metal in the transition metal hydroxide was the ratio shown in Table 1 (Li/TM). The resulting mixture was baked in an oxygen atmosphere in a baking furnace (muffle furnace). For sintering of the mixture, a first sintering, a second sintering and a third sintering were carried out in this order at the temperatures and for the times shown in Table 1. The obtained sintered product was pulverized by a pulverizer (jet mill), and crushed to a predetermined particle diameter. As a result, a positive electrode active material powder precursor was obtained.

### [1.3] Post-Processing

Using a mortar, the positive electrode active material powder precursor was crushed and passed through a sieve having an opening of 32 μm. Thereafter, the powder passed through the sieve was subjected to the post-treatment shown in Table 1. Post-treatment refers to washing treatment, sintering treatment and sieving treatment being carried out in this order. “Washing treatment” refers to water washing. “Sintering treatment” refers to sintering at the temperature and for the time shown in Table 1 in an oxygen atmosphere. “Sieving treatment” refers to a treatment in which particles that do not pass through a sieve having the opening shown in Table 1 are excluded. As a result, a positive electrode active material powder was obtained. The positive electrode active material powder was an aggregate of particles of lithium transition metal oxide having a layered crystal structure. The lithium transition metal oxide contained Ni, Co and Mn.

TABLE 1

| | Crystallization | | | Sintering | | | |
|---|---|---|---|---|---|---|---|
| | | | Molar | Molar | First | | Second |
| | | Stirring | Ratio | Ratio | Sintering | | Sintering |
| | pH | Speed | (NH₃/TM) | (Li/TM) | Temp. | Time | Temp. |
| | — | rpm | — | — | ° C. | Hours | ° C. |
| Comparative | 10.0 | 1000 | 6 | 1.01 | 1000 | 20 | — |
| Example 1 | | | | | | | |
| Comparative | 10.0 | 1000 | 6 | 1.20 | 950 | 20 | — |
| Example 2 | | | | | | | |
| Example 1 | 11.3 | 600 | 2 | 1.40 | 500 | 10 | 800 |
| Example 2 | 11.3 | 600 | 2 | 1.40 | 500 | 10 | 780 |
| Example 3 | 11.3 | 600 | 2 | 1.40 | 500 | 10 | 800 |
| Example 4 | 11.3 | 600 | 2 | 1.40 | 500 | 10 | 800 |

| | Sintering | | | Post-Treatment | | | |
|---|---|---|---|---|---|---|---|
| | Second | Third | | Washing | Sintering | | Sieving |
| | Sintering | Sintering | | Treatment | Treatment | | Treatment |
| | Time | Temp. | Time | Y/N | Temp. | Time | Opening |
| | Hours | ° C. | Hours | — | ° C. | Hours | μm |
| Comparative | — | — | — | N | 850 | 1 | 32 |
| Example 1 | | | | | | | |
| Comparative | — | — | — | N | — | — | — |
| Example 2 | | | | | | | |
| Example 1 | 20 | 700 | 5 | Y | 600 | 5 | 32 |
| Example 2 | 15 | 700 | 1 | Y | 600 | 1 | 32 |
| Example 3 | 13 | 700 | 5 | Y | 600 | 1 | 25 |
| Example 4 | 16 | 700 | 5 | Y | 600 | 5 | 25 |

In Table 1, “-” for the second sintering and the third sintering indicate that the second sintering and the third sintering were not performed. “-” for the sintering treatment indicates that the sintering treatment was not performed. “-” for the sieving treatment indicates that the sieving treatment was not carried out.

### [1.4] Measurement of Coarse Secondary Particle Ratio and Microparticle Ratio

From the obtained positive electrode active material powder, using a scanning microscope (manufactured by Thermo Fisher Scientific Co., Ltd.), a scanning micrograph of the positive electrode active material powder in a field of view in which 50 or more particles (A) were contained, was captured. The number of particles (A) and the number of coarse secondary particles in the scanning micrograph were measured. Using particle analysis software (manufactured by Thermo Fisher Scientific Co., Ltd.), the circle equivalent diameter of the particles in the scanning micrograph was calculated, and the number of particles (A) having a circle equivalent diameter of 0.8 μm or less was measured.

From the following formula (i), the coarse secondary particle ratio was calculated. The microparticle ratio was calculated from the following formula (ii). The results are shown in Table 2.

$$coarse secondary particle ratio ( number \% ) = \qquad Formula ( i )$$

$$[ number of coarse secondary particles \div number of particles ( A ) ] \times 100$$

$$microparticle ratio ( number \% ) = \qquad Formula ( ii )$$

$$[ number of particles having circle equivalent diameter of 0.8 µm$$

$$or less \div the number of particles ( A ) ] \times 100$$

### [2] Evaluation of Resistance Increase Rate

A lithium secondary battery (hereinafter, also referred to as an “evaluation battery”) was prepared using the positive electrode active material powder as follows, and the resistance increase rate was measured.

### [2.1] Production of Evaluation Battery

As materials of the positive electrode, the obtained positive electrode active material powder, acetylene black (Denka Co., Ltd.) as a conductive material, PVDF (Kureha Co., Ltd.) as a binder, and aluminum foil (thickness: 15 μm) as a positive electrode current collector, were prepared. A positive electrode was prepared from the above materials.

As materials for the negative electrode, natural graphite (Hitachi Chemical Co., Ltd.) as a negative electrode active material, CMC (Nippon Paper Industries, Ltd.) and SBR (JSR Co., Ltd.) as binders, and copper foil (thickness: 10 μm) as the negative electrode current collector, were prepared. A negative electrode was prepared using the materials described above.

As a separator, a porous resin (PP/PE/PP) (thickness: 24 μm) in which PP layers were layered on both sides of the PE layer was prepared. The positive electrode, the separator, and the negative electrode were layered so that the separator separated the positive electrode from the negative electrode. As a result, an electrode body was formed.

As the exterior body, a pouch made of a laminate film was prepared. The electrode body was housed in the exterior body. As the nonaqueous electrolytic solution, a solution was used in which a support salt (LiPF₆) was dissolved in a mixed solvent containing ECs, DMCs, and EMCs at a concentration of 1 mol/L. The electrolytic solution was injected into the exterior body. After injection of the electrolytic solution, the exterior body was sealed. As a result, the evaluation battery was manufactured.

### [2.2] Measurement of Resistance Increase Rate

### [2.2.1] Initial Resistance

In a 25° C. temperature environment, the SOC (state of charge) of the evaluation battery was adjusted to 50% by constant current-constant voltage (CC-CV) charging. The current during constant current (CC) charging was 1 It. “1 It” is defined as the current at which the rated capacity of the battery is reached in one hour. At 50% SOC, the voltage of the battery was 3.7V. After adjusting the SOC, the battery was discharged at a current of 10 It for 10 seconds following a 30 minute pause. In accordance with the following formula (iii), an initial discharge resistance (initial resistance) was obtained.

$$r = ( {V}_{0} - {V}_{10} ) / current \qquad Formula ( iii )$$

In Formula (iii), “r” represents a discharge resistance. “V₀” represents the current at the beginning of discharging. “V₁₀” indicates the current after 10 seconds have elapsed since the beginning of discharging.

### [2.2.2] Resistance Increase Rate

After measuring the initial resistance, in a temperature environment of 25° C., the SOC of the battery was adjusted to 80% by CC-CV charging. The current at the time of CC charging was 1 It. After adjusting the SOC, a cycle test was carried out in a temperature environment of 25° C. Specifically, the following discharging and charging were alternately repeated for 15 days.
Discharging: current=1 It, discharging capacity=capacity corresponding to 20% SOC
Charging: current=1 It, charging capacity=capacity corresponding to 20% SOC

After the cycle test, the discharge resistance (post-cycle resistance) after the cycle was measured in the same manner as the initial resistance. The resistance increase rate (percentage) was determined by dividing the post-cycle resistance by the initial resistance. The results are shown in Table 2. The resistance increase rate in Table 2 is a relative value.

The resistance increase rate of Comparative Example 1 is defined as 1. An acceptable range of the resistance increase rate is less than 1.

TABLE 2

| | Positive Electrode Active Material Powder | | Evaluation |
|---|---|---|---|
| | Coarse Secondary | Microparticle | Resistance |
| | Particle Ratio | Ratio | Increase Rate |
| | Number % | Number % | — |
| Comparative | 50 | 0.80 | 1 |
| Example1 | | | |
| Comparative | 27 | 2.20 | 1.03 |
| Example2 | | | |
| Example 1 | 45 | 0.90 | 0.83 |
| Example 2 | 26 | 1.50 | 0.86 |
| Example 3 | 18 | 0.80 | 0.76 |
| Example 4 | 28 | 0.80 | 0.78 |

### [3] Results

In Comparative Example 1, the coarse secondary particle ratio was not 45 number % or less. In Comparative Example 2, the microparticle ratio was not 1.5 number % or less. Therefore, in Comparative Example 1 and Comparative Example 2, the resistance increase rate was not less than 1. As a result, it was found that the positive electrode active material powder of Comparative Example 1 and Comparative Example 2 was not “a positive electrode active material powder capable of reducing the resistance increase rate of a lithium secondary battery”.

In Examples 1 to 4, the proportion of coarse secondary particles was 45 number % or less and the microparticle ratio was 1.5 number % or less. Therefore, in Examples 1 to 4, the resistance increase rate was less than 1. As a result, it was found that the positive electrode active material powders of Examples 1 to 4 were “positive electrode active material powders capable of reducing the resistance increase rate of lithium secondary batteries”.

What is claimed is:

1. A positive electrode active material powder of a lithium secondary battery, the powder comprising a plurality of particles (A) configured by a positive electrode active material, wherein:
the plurality of particles (A) comprises a plurality of primary particles (A1) and a plurality of secondary particles (A2) formed by sintering together primary particles (A1),
in a scanning micrograph of the positive electrode active material powder in a field of view containing 50 or more of the particles (A), a ratio of a plurality of coarse secondary particles is 45 number % or lower relative to a total number of the plurality of particles (A) inside the field of view,
the plurality of coarse secondary particles are, among the plurality of secondary particles (A2), a plurality of the secondary particles formed by sintering together 5 or more of the primary particles (A1),
a ratio of a plurality of microparticles is 1.5 number % relative to the total number of the plurality of particles (A) inside the field of view, and
the plurality of microparticles are, among the plurality of particles (A), a plurality of the particles (A) having a circle equivalent diameter of 0.8 μm or less.

2. The positive electrode active material powder of claim 1, wherein:
the ratio of the coarse secondary particles is 28 number % or lower relative to the total number of the plurality of particles (A) inside the field of view, and
the ratio of the microparticles is 0.8 number % relative to the total number of the plurality of particles (A) inside the field of view.

3. The positive electrode active material powder of claim 1, wherein the positive electrode active material is a lithium transition metal oxide having a layered crystalline structure.

4. The positive electrode active material powder of claim 3, wherein the lithium transition metal oxide includes at least one of Ni, Co or Mn.

5. A lithium secondary battery, comprising a positive electrode including the positive electrode active material powder of any one of claims 1.
